(19) United States
(12) Patent Application Publication
(10) Pub. No.: US 2024/0157757 A1
(43) Pub. Date: May 16, 2024

(54) Vehicle air conditioning apparatus

(71) Applicant: SANDEN AUTOMOTIVE CLIMATE SYSTEM CORPORATION, Gunma (JP)

(72) Inventors: Megumi SHIGETA, Gunma (JP); Ryo MIYAKOSHI, Gunma (JP); Yoshiyuki OKAMOTO, Gunma (JP)

(21) Appl. No.: 18/550,420

(22) PCT Filed: Mar. 22, 2022
(86) PCT No.: PCT/JP2022/013274

§ 371 Date: Sep. 13, 2023

(30) Foreign Application Priority Data
Mar. 24, 2021 (JP) 2021-050514

(51) Int. Cl. B60H 1/00; B60H 1/22; F25B 47/02

(52) U.S. Cl. CPC B60H 1/00328; B60H 1/00021; B60H 1/00807; B60H 1/2218; F25B 47/022; B60H 2001/00114; B60H 1/00428; F25B 2600/2513

(57) ABSTRACT

A vehicle air conditioning apparatus includes: a refrigerant circuit including a compressor configured to compress refrigerant, an outdoor heat exchanger configured to perform a heat exchange between the refrigerant and outdoor air, and a heat absorption heat exchanger configured to absorb heat from a heat-absorbed subject; and a controller configured to control the refrigerant circuit. The controller can selectively perform a plurality of defrosting modes including: a hot gas defrosting mode to defrost the outdoor heat exchanger by the refrigerant compressed by the compressor; and a heat absorption defrosting mode to defrost the outdoor heat exchanger by the refrigerant absorbing the heat from the heat-absorbed subject and compressed by the compressor. The controller sets a hot gas defrosting priority condition to preferentially select the hot gas defrosting mode.

### TECHNICAL FIELD

The present invention relates to a vehicle air conditioning apparatus applicable to a vehicle, and specifically to a vehicle air conditioning apparatus configured to defrost an outdoor heat exchanger.

### BACKGROUND ART

Conventionally, an air conditioning apparatus applicable to a vehicle includes a refrigerant circuit in which a compressor, an indoor heat exchanger (serving as an evaporator during cooling and as a condenser during heating), an outdoor heat exchanger (serving as a condenser during cooling and as an evaporator during heating), and an expansion valve are connected, and is configured to perform air conditioning by supplying a vehicle compartment with air having been subjected to a heat exchange with refrigerant in the indoor heat exchanger.

In this vehicle air conditioning apparatus, the outdoor heat exchanger functions as a heat absorbing device during the heating operation, and therefore, when the outdoor temperature is low, condensed water is frozen on the surface of the outdoor heat exchanger and consequently frost may be formed. When the frost is formed, the heat transfer coefficient is decreased so that sufficient heat is not absorbed. Therefore, it is not possible to sufficiently heat the vehicle compartment, and consequently it is required to perform defrosting operation. For example, there has been known a vehicle air conditioning apparatus configured to perform the defrosting operation with appropriate performance depending on the situation when the frost is formed on the outdoor heat exchanger, by switching between a strong defrosting operation mode to circulate the refrigerant through the outdoor heat exchanger and a weak defrosting operation mode to bypass the outdoor heat exchanger after the refrigerant discharged from a compressor is flowed to an indoor heat exchanger (for example, Patent Literature 1).

### CITATION LIST

### Patent Literature

PTL1: Japanese Patent Application Laid-Open No. 2014-196018

### SUMMARY OF INVENTION

### Problem to be Solved by the Invention

However, in the vehicle air conditioning apparatus disclosed in Patent Literature 1 described above, during the defrosting operation in the strong defrosting operation mode, when the outdoor temperature is too low, heat loss in the pipes and the heat release from the outdoor heat exchanger are large, and therefore the amount of heat required for the defrosting is not sufficient only by the heat from the compressor. Consequently, it may not be possible to fully and evenly remove the frost. Meanwhile, the weak defrosting operation mode is selected to melt the frost on the outdoor heat exchanger in a case where the frost is formed on the outdoor heat exchanger during the heating when the outdoor temperature is relatively high (higher than 0 degrees Celsius). In this operation mode, the refrigerant is not circulated in the outdoor heat exchanger, and therefore not to actively defrost the outdoor heat exchanger, and consequently the frost may not be evenly removed.

The invention is proposed to address the above-described problems, and it is therefore an object of the invention to surely and evenly remove the frost depending on the situation of a vehicle.

### Solution to Problem

An aspect of the invention provides a vehicle air conditioning apparatus including: a refrigerant circuit including a compressor configured to compress refrigerant, an outdoor heat exchanger configured to perform a heat exchange between the refrigerant and outdoor air, and a heat absorption heat exchanger configured to absorb heat from a heat-absorbed subject; and a controller configured to control the refrigerant circuit. The controller can selectively perform a plurality of defrosting modes including: a hot gas defrosting mode to defrost the outdoor heat exchanger by the refrigerant compressed by the compressor; and a heat absorption defrosting mode to defrost the outdoor heat exchanger by the refrigerant absorbing the heat from the heat-absorbed subject and compressed by the compressor. The controller sets a hot gas defrosting priority condition to preferentially select the hot gas defrosting mode.

### Effect of the Invention

According to the invention, it is possible to surely and evenly remove the frost depending on the situation of a vehicle.

### BRIEF DESCRIPTION OF DRAWINGS

FIG. 1 illustrates a schematic configuration of a refrigerant circuit of a vehicle air conditioning apparatus according to an embodiment of the invention;

FIG. 2 is a block diagram illustrating a schematic configuration of a heat pump ECU as a controller of the vehicle air conditioning apparatus according to the embodiment of the invention;

FIG. 3 illustrates the flow of refrigerant to defrost an outdoor heat exchanger in a hot gas defrosting mode of the vehicle air conditioning apparatus according to the embodiment of the invention;

FIG. 4 illustrates the flow of refrigerant to defrost the outdoor heat exchanger in a chiller defrosting mode of the vehicle air conditioning apparatus according to the embodiment of the invention;

FIG. 5 illustrates the flow of refrigerant to defrost the outdoor heat exchanger in a cooling cycle defrosting mode of the vehicle air conditioning apparatus according to the embodiment of the invention;

FIG. 6 is a table illustrating the relationship among the capacity of a compressor, the opening area of the outdoor heat exchanger, and the outdoor temperature (threshold);

FIG. 7 is a graph illustrating the relationship between the outdoor temperature and defrosting index P;

FIG. 8 is a flowchart illustrating a process of selecting and switching defrosting modes of the vehicle air conditioning apparatus according to the embodiment of the invention, where the chiller defrosting is selected as a heat absorption defrosting; and

FIG. 9 is a flowchart illustrating a process of selecting and switching defrosting modes of the vehicle air conditioning apparatus according to the embodiment of the invention, where a cooling cycle defrosting is selected as the heat absorption defrosting.

### DESCRIPTION OF EMBODIMENTS

Hereinafter, an embodiment of the invention will be described in detail with reference to the drawings. In the description below, the same reference number in different drawings denotes the same component with the same function, and duplicate description for each of the drawings is omitted accordingly.

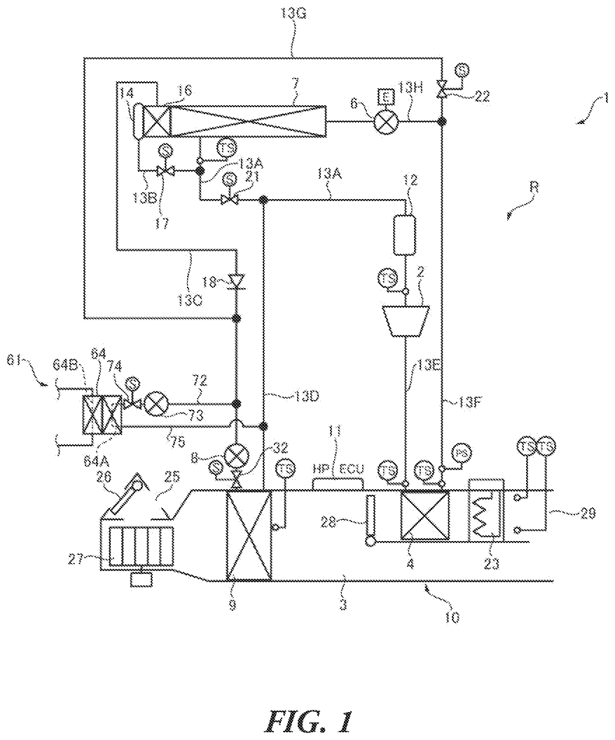

FIG. 1 illustrates a schematic configuration of a vehicle air conditioning apparatus 1 according to an embodiment of the invention. The vehicle air conditioning apparatus 1 is applicable to vehicles, for example, an electric vehicle (EV) without an engine (internal combustion), and a so-called hybrid vehicle using an engine and an electric drive motor together. This vehicle includes a battery (e.g. a lithium battery), and is configured to drive and run by supplying the power of the battery charged by an external power source to a motor unit including the drive motor. Also the vehicle air conditioning apparatus 1 is driven by the power supplied from the battery.

The vehicle air conditioning apparatus 1 according to the present embodiment includes a refrigerant circuit R, and performs heat pump operation with use of the refrigerant circuit R to perform air conditioning (heating, cooling, dehumidifying, and defrosting) of a vehicle compartment. In addition, a heat medium circuit connected to the refrigerant circuit R is used to cool and warm up electric devices such as a battery and a motor. Here, in the description below, “refrigerant” is circulating medium whose state varies (compressed, condensed, expanded, and evaporated) in a heat pump of the refrigerant circuit, and “heat medium” is medium configured to absorb and release heat without varying its state.

The refrigerant circuit R includes: an electric motor-driven compressor 2 configured to compress refrigerant, an indoor condenser (heat releasing device) 4, as an indoor heat exchanger, provided in an air flow passage 3 of an HVAC unit 10 through which the air of the vehicle compartment is ventilated and circulated, and configured to release the heat from the refrigerant having a high temperature and a high pressure discharged from the compressor 2 and heat the air to be supplied into the vehicle compartment; an outdoor expansion valve 6 configured to decompress and expand the refrigerant during the heating; an outdoor heat exchanger 7 functioning as a heat releasing device (condenser) to release the heat from the refrigerant during the cooling, and configured to perform a heat exchange between the refrigerant and the outdoor air to function as an evaporator to absorb the heat into the refrigerant during the heating; an indoor expansion valve 8 configured to decompress and expand the refrigerant; a heat absorbing device (heat absorption heat exchanger) 9 provided in the air flow passage 3 and configured to absorb the heat into the refrigerant from the inside and the outside of the vehicle compartment to cool the air to be supplied into the vehicle compartment during the cooling and the dehumidifying; and an accumulator 12, which are connected by refrigerant pipes 13A to 13H.

The outdoor expansion valve 6 and the indoor expansion valve 8 are electronic expansion valves driven by a pulse motor (not illustrated), and the degree of opening of them is appropriately controlled between the full closing and the full opening based on the number of pulses applied to the pulse motor. The outdoor expansion valve 6 decompresses and expands the refrigerant having flowed from the indoor condenser 4 and flowing into the outdoor heat exchanger 7. In addition, during the heating using the outdoor heat exchanger 7, the degree of opening of the outdoor expansion valve 6 is controlled by a heat pump ECU 11 described later, so as to make a SC (sub-cooling) value as an indicator of the achievement of supercooling at the refrigerant outlet of the indoor condenser 4 attain to a predetermined target value (SC control). The indoor expansion valve 8 decompresses and expands the refrigerant flowing into the heat absorbing device 9, and adjusts the degree of superheat of the refrigerant in the heat absorbing device 9.

An outdoor blower (not illustrated) is provided in the outdoor heat exchanger 7. The outdoor blower forcibly ventilates the outdoor heat exchanger 7 by the outdoor air to cause a heat exchange between the outdoor air and the refrigerant, and allows the outdoor heat exchanger 7 to be ventilated by the outdoor air even during the stop of the vehicle.

A receiver dryer 14 and a supercooling device 16 are provided in the outdoor heat exchanger 7 on the downstream side with respect to the refrigerant flow. The refrigerant outlet side of the outdoor heat exchanger 7 is connected to the receiver dryer 14 via the refrigerant pipe 13A and the refrigerant pipe 13B branching from the refrigerant pipe 13A. A solenoid valve 17 (for cooling) is provided in the refrigerant pipe 13B, as an on-off valve configured to open to flow the refrigerant to the heat absorbing device 9.

The outlet side of the supercooling device 16 is connected to the refrigerant inlet side of the heat absorbing device 9 via the refrigerant pipe 13C. A check valve 18, an indoor expansion valve 8 and a solenoid valve 32 as an indoor heat exchanger valve (on-off valve) are provided in the refrigerant pipe 13C in this order from the outdoor heat exchanger 7 side. The check valve 18 is provided in the refrigerant pipe 13C such that the direction toward the heat absorbing device 9 is the forward direction.

Meanwhile, a solenoid valve 21 (for heating) as an on-off valve configured to open during the heating, the accumulator 12 and the compressor 2 are connected in series to the refrigerant pipe 13A extending from the outdoor heat exchanger 7. The refrigerant pipe 13A branches into the refrigerant pipe 13D between the outlet side of the solenoid valve 21 and the inlet side of the accumulator 12, and the refrigerant pipe 13D is connected to the refrigerant outlet side of the heat absorbing device 9.

The refrigerant outlet of the compressor 2 is connected to the refrigerant inlet of the indoor condenser 4 by the refrigerant pipe 13E. One end of the refrigerant pipe 13F is connected to the refrigerant outlet of the indoor condenser 4, and the other end of the refrigerant pipe 13F branches into the refrigerant pipe 13G and the refrigerant pipe 13H upstream of the outdoor expansion valve 6 (with respect to the refrigerant flow).

The refrigerant pipe 13H branched from the refrigerant pipe 13F is connected to the refrigerant inlet of the outdoor heat exchanger 7 via the outdoor expansion valve 6. Meanwhile, the refrigerant pipe 13G branched from the refrigerant pipe 13F is connected to the refrigerant pipe 13C between the check valve 18 and the indoor expansion valve 8. A solenoid valve 22 is provided in the refrigerant pipe 13G upstream from the connection point to the refrigerant pipe 13C with respect to the refrigerant flow.

By this means, the refrigerant pipe 13G is connected in parallel to a series circuit including the outdoor expansion valve 6, the outdoor heat exchanger 7 and the check valve 18, and forms a bypass circuit configured to bypass the outdoor expansion valve 6, the outdoor heat exchanger 7, and the check valve 18.

An outdoor air intake port and an indoor air intake port (representatively illustrated as “intake port 25” in FIG. 1) are formed upstream of the heat absorbing device 9 with respect to the air flow in the air flow passage 3. An intake switching damper 26 is provided in the intake port 25. The intake switching damper 26 appropriately switches between the indoor air which is the air in the vehicle compartment (indoor air circulation) and the outdoor air which is the air outside the vehicle compartment (outdoor air introduction) to introduce the air from the intake port 25 into the air flow passage 3. An indoor blower (blower fan) 27 is provided downstream of the intake switching damper 26 with respect to the air flow, and configured to supply the introduced indoor air and outdoor air to the air flow passage 3.

In FIG. 1, an auxiliary heater 23 functions as an auxiliary heating device. The auxiliary heater 23 is an electric heater such as a PTC heater, and is provided in the air flow passage 3 on the downstream side of the indoor condenser 4 with respect to the air flow of the air flow passage 3. The auxiliary heater 23 is turned on and generates heat to supplement the heating in the vehicle compartment.

An air mix damper 28 is provided upstream of the indoor condenser 4 with respect to the air flow in the air flow passage 3, and configured to adjust the ratio between the indoor condenser 4 and the auxiliary heater 23 through which the air (the indoor air and the outdoor air) having flowed into the air flow passage 3 and passed through the heat absorbing device 9 is ventilated.

Here, as auxiliary heating means, for example, it may circulate hot water heated by the waste heat of the compressor through a heater core disposed in the air flow passage 3 to heat the air to be sent.

A refrigerant-heat medium heat exchanger 64 (heat absorption heat exchanger) is connected to the refrigerant circuit R. The refrigerant-heat medium heat exchanger 64 includes a refrigerant flow path 64A and a heat medium flow path 64B, and constitutes part of the refrigerant circuit R and also part of a heat medium circuit 61 such as a device temperature adjustment circuit (not illustrated).

To be more specific, the refrigerant-heat medium heat exchanger 64 is connected to the refrigerant circuit R as follows. One end of a refrigerant pipe 72 as a branching circuit is connected to the refrigerant circuit R downstream of the check valve 18 provided in the refrigerant pipe 13C and upstream of the indoor expansion valve 8 with respect to the refrigerant flow. A chiller expansion valve 73, and a solenoid valve 74 as an on-off valve are provided in the refrigerant pipe 72.

The chiller expansion valve 73 is an electronic expansion valve driven by a pulse motor (not illustrated), and has the degree of opening which is appropriately controlled between the full closing and the full opening based on the number of pulses applied to the pulse motor. The chiller expansion valve 73 decompresses and expands the refrigerant flowing into the refrigerant flow path 64A of the refrigerant-heat medium heat exchanger 64, and adjusts the degree of superheat of the refrigerant in the refrigerant flow path 64A of the refrigerant-heat medium heat exchanger 64.

In the refrigerant-heat medium heat exchanger 64, the other end of the refrigerant pipe 72 is connected to the inlet of the refrigerant flow path 64A, and one end of a refrigerant pipe 75 is connected to the outlet of the refrigerant flow path 64A. The other end of the refrigerant pipe 75 is connected to the refrigerant pipe 13D upstream from the heat exchanger 9 with respect to the refrigerant flow. In this way, the chiller expansion valve 73, the solenoid valve 74, and the refrigerant flow path 64A of the refrigerant-heat medium heat exchanger 64 also constitute part of the refrigerant circuit R, and constitute part of the heat medium circuit 61.

When the chiller expansion valve 73 is open, part or the whole of the refrigerant having circulated through the refrigerant circuit R and flowed from the refrigerant pipe 13G and the outdoor heat exchanger 7 flows into the refrigerant pipe 72, is decompressed by the chiller expansion valve 73, flows into the refrigerant flow path of the refrigerant-heat medium heat exchanger 64, and evaporates. The heat medium flows into the heat medium flow path 64B. For example, when the heat medium circuit 61 is a device temperature adjustment circuit, the heat medium circulating through temperature-adjusted subjects such as a battery and a motor unit flows into the heat medium flow path 64B.

While flowing through the refrigerant flow path 64A of the refrigerant-heat medium heat exchanger 64, the refrigerant absorbs the heat from the heat medium flowing through the heat medium flow path 64B. By this means, when the heat medium circuit 61 is a device temperature adjustment circuit, the heat medium circuit 61 performs a heat exchange between the heat medium circulating in the temperature-adjusted subjects such as a battery and a motor unit and the refrigerant circulating through the refrigerant circuit R to adjust the temperatures of the battery and the motor unit. As the heat medium, for example, water, refrigerant such as HFO-1234yf, liquid such as coolant, and gas such as air may be adopted.

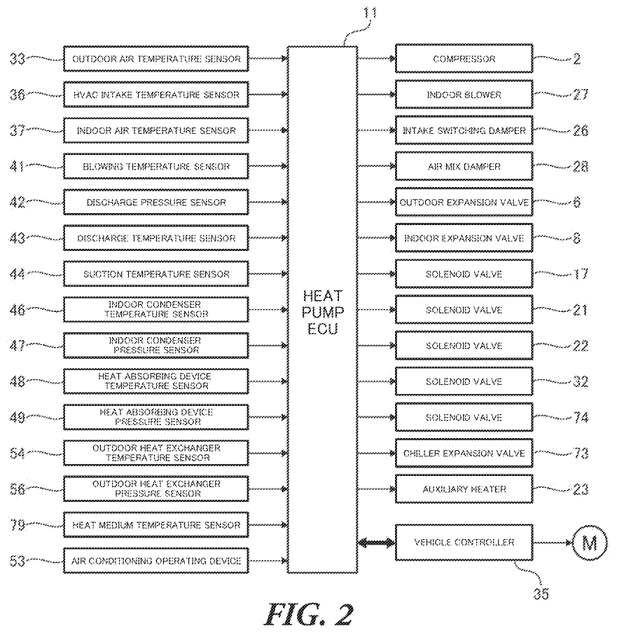

FIG. 2 illustrates a schematic configuration of the heat pump ECU 11 as a controller of the vehicle air conditioning apparatus 1. The heat pump ECU 11 is connected to a vehicle controller 35 for the general control of the vehicle including the control of driving, via an in-vehicle network such as a CAN (controller area network) and a LIN (local interconnect network), and therefore can communicate with one another, and send and receive information. A microcomputer as an example of a computer with a processor is applicable to each of the heat pump ECU 11 and the vehicle controller 35.

Various sensors and detectors are connected to the heat pump ECU 11 as follows, and outputs of these sensors and detectors are inputted to the heat pump ECU 11. To be more specific, the heat pump ECU 11 is connected to an outdoor air temperature sensor 33 configured to detect outdoor air temperature Tam of the vehicle; an HVAC intake temperature sensor 36 configured to detect the temperature of the air taken from the intake port 25 into the air flow passage 3; an indoor air temperature sensor 37 configured to detect the temperature of the air in the vehicle compartment (indoor air temperature Tin); a blowing temperature sensor 41 configured to detect the temperature of the air blowing from a blowing outlet 29 to the vehicle compartment; a discharge pressure sensor 42 configured to detect the pressure of the refrigerant discharged from the compressor 2 (discharge pressure Pd); a discharge temperature sensor 43 configured to detect temperature Td of the refrigerant discharged from the compressor 2; a suction temperature sensor 44 configured to detect temperature Ts of the refrigerant sucked into the compressor 2; an indoor condenser temperature sensor 46 configured to detect the temperature of the indoor condenser 4 (the temperature of the refrigerant having passed through the indoor condenser 4, or the temperature of the indoor condenser 4 itself: indoor condenser temperature TCI); an indoor condenser pressure sensor 47 configured to detect the pressure of the indoor condenser 4 (the pressure of the refrigerant just after exiting from the indoor condenser 4: indoor condenser exit pressure Pci); a heat absorbing device temperature sensor 48 configured to detect the temperature of the heat absorbing device 9 (the temperature of the air having passed through the heat absorbing device 9, or the temperature of the heat absorbing device 9 itself: heat absorbing device temperature Te); a heat absorbing device pressure sensor 49 configured to detect the refrigerant pressure of the heat absorbing device 9 (the pressure of the refrigerant in the heat absorbing device 9, or the pressure of the refrigerant just after exiting from the heat absorbing device 9); an air conditioning operating device 53 configured to set the preset temperature and the switching of the air conditioning operation; an outdoor heat exchanger temperature sensor 54 configured to detect temperature of the outdoor heat exchanger 7 (temperature TXO of the refrigerant just after being discharged from the outdoor heat exchanger 7); and an outdoor heat exchanger pressure sensor 56 configured to detect the refrigerant pressure of the outdoor heat exchanger 7 (the pressure of the refrigerant just after being discharged from the outdoor heat exchanger 7: discharged refrigerant pressure PXO).

In addition to the above-described components, the heat pump ECU 11 is connected to a heat medium temperature sensor 79 configured to detect temperature Tw (hereinafter, referred to as “chiller water temperature”) of the heat medium having exited from the heat medium flow path of the refrigerant-heat medium heat exchanger 64 and circulating through the heat medium circuit.

On the other hand, the output of the heat pump ECU 11 is connected to the compressor 2, the outdoor blower (not illustrated), the indoor blower (blower fan) 27, the intake switching damper 26, the air mix damper 28, the outdoor expansion valve 6, the indoor expansion valve 8, the solenoid valves 17, 21, 22, 35, and 74, the auxiliary heater 23, and the chiller expansion valve 73. The heat pump ECU 11 controls these components based on the output of each of the sensors, the setting inputted by the air conditioning operating device 53, and the information from the vehicle controller 35.

When the vehicle air conditioning apparatus 1 configured as described above performs the heating operation, the refrigerant evaporates in the outdoor heat exchanger 7, and absorbs the heat from the outdoor air to reduce the temperature of the outdoor heat exchanger 7, and therefore the moisture of the outdoor air becomes frost and adheres to the surface of the outdoor heat exchanger 7. Therefore, it is required to defrost the outdoor heat exchanger 7. In this case, the vehicle air conditioning apparatus 1 appropriately selects or switches between a plurality of defrosting operation modes depending on the situation of the vehicle to defrost the outdoor heat exchanger 7.

To be more specific, the vehicle air conditioning apparatus 1 according to the present embodiment appropriately selects between a hot gas defrosting mode to perform defrosting with so-called hot gas, and a heat absorption defrosting mode to absorb the heat into the refrigerant circulating through the refrigerant circuit R in the refrigerant-heat medium heat exchanger 64 or the heat absorbing device 9 and release the heat from the refrigerant in the outdoor heat exchanger 7.

The hot gas defrosting mode can almost evenly remove the frost, and be easily controlled, but has low defrosting performance because it depends on only the compressor 2 to adjust the temperature of the refrigerant. Accordingly, when the outdoor temperature is too low, it may not be possible to surely remove the frost.

On the other hand, in the heat absorption defrosting mode, the heat is absorbed into the refrigerant in the refrigerant-heat medium heat exchanger 64 or the heat absorbing device 9, and the refrigerant is compressed by the compressor 2 to increase the temperature and the pressure of the refrigerant to high levels. In addition, an auxiliary heat source can be used, and therefore the heat absorption defrosting mode has high defrosting performance and can be used even when the outdoor temperature is too low.

Therefore, the vehicle air conditioning apparatus 1 according to the present embodiment can surely and evenly remove the frost by selecting or switching between the hot gas defrosting mode and the heat absorption defrosting mode, based on preset conditions (described in detail later) depending on the situation of the vehicle (the size of the heat exchanger, the capacity of the compressor, the outdoor temperature and so forth).

### <Hot Gas Defrosting Mode>

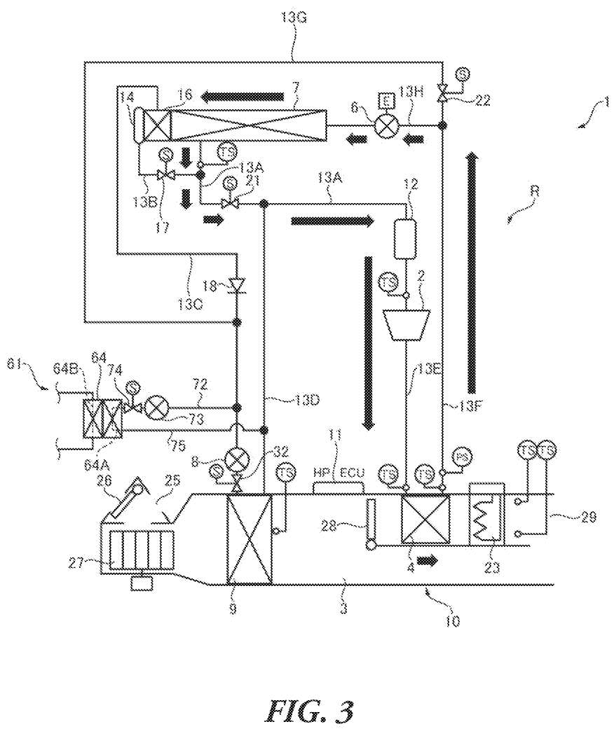

FIG. 3 illustrates the flow of refrigerant in the refrigerant circuit R to defrost the outdoor heat exchanger 7 in the hot gas defrosting mode. In the hot gas defrosting mode, the heat pump ECU 11 fully opens the outdoor expansion valve 6 and actuates the compressor 2 to allow the refrigerant having a high temperature and a high pressure discharged from the compressor 2 to flow into the indoor condenser 4 while the refrigerant circuit R is set for the heating operation. Here, in the hot gas defrosting mode, the heat of the refrigerant is used for the defrosting, and therefore the refrigerant is hardly condensed in the indoor condenser 4 and merely passes through the indoor condenser 4. The refrigerant having exited from the indoor condenser 4 passes through the refrigerant pipe 13F, reaches the refrigerant pipe 13H, passes through the outdoor expansion valve 6, and flows into the outdoor heat exchanger 7. The refrigerant with a high temperature and a high pressure having flowed into the outdoor heat exchanger 7 releases the heat in the outdoor heat exchanger 7, and melts the frost. The outdoor heat exchanger 7 is defrosted by the sensible heat and the latent heat of the refrigerant. Therefore, the hot gas defrosting mode can evenly defrost the outdoor heat exchanger 7. Here, during the defrosting, the outdoor blower is stopped, and, when a grille shutter is provided, it is closed.

### <Heat Absorption Defrosting Mode>

The heat absorption defrosting mode includes, for example, a chiller defrosting mode to allow the refrigerant-heat medium heat exchanger 64 to function as a heat absorbing device, and a cooling cycle defrosting mode to use the heat absorbing device 9. Hereinafter, the chiller defrosting mode and the cooling cycle defrosting mode will be described.

### (1) Chiller Defrosting

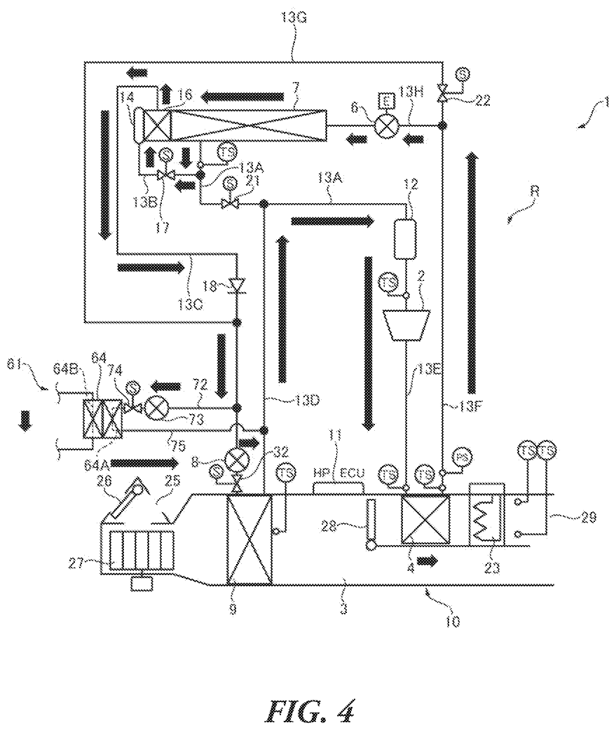

FIG. 4 illustrates the flow of refrigerant in the refrigerant circuit R to defrost the outdoor heat exchanger 7 in the chiller defrosting mode. In the chiller defrosting mode, the heat pump ECU 11 opens the solenoid valve 17 to allow the refrigerant having exited from the outdoor heat exchanger 7 to pass through the receiver dryer 14, the supercooling device 16, and the check valve 18, and flow into the refrigerant pipe 72. In addition, the heat pump ECU 11 opens the chiller expansion valve 73 and the solenoid valve 74 to allow the refrigerant to flow into the refrigerant flow path 64A of the refrigerant-heat medium heat exchanger 64. In the refrigerant flow path 64A, the refrigerant absorbs the heat from the heat medium having circulated through the heat medium circuit 61.

The heat pump ECU 11 closes at least one of the indoor expansion valve 8 and the solenoid valve 32 to allow the refrigerant having absorbed the heat to flow into the refrigerant pipes 13D and 13A via the refrigerant pipe 75, fully opens the outdoor expansion valve 6, actuates the compressor 2, and flows the refrigerant into the compressor 2. Then, the refrigerant compressed and discharged from the compressor 2, which has a high temperature and a high pressure, passes through the indoor condenser 4, and the outdoor expansion valve 6, and flows into the outdoor heat exchanger 7. The refrigerant with a high temperature and a high pressure having flowed into the outdoor heat exchanger 7 releases the heat in the outdoor heat exchanger 7 and melts the frost. The outdoor heat exchanger 7 is defrosted by the latent heat of the refrigerant. Here, during the defrosting, the outdoor blower is stopped, and, when a grille shutter is provided, it is closed.

In the chiller defrosting mode, the defrosting performance depends on not only the performance of the compressor 2, but also the degree of heat absorption of the refrigerant in the refrigerant-heat medium heat exchanger 64. Incidentally, for example, an electric coolant heater (ECH) as an auxiliary heat source provided in the heat medium circuit 61 is appropriately actuated, and therefore it is possible to raise the temperature of the heat medium circulating through the heat medium circuit 61. Therefore, the electric coolant heater is supplementarily used to complement the amount of heat absorbed from the heat medium into the refrigerant, and consequently it is possible to complement the defrosting performance in the chiller defrosting mode.

### (2) Cooling Cycle Defrosting

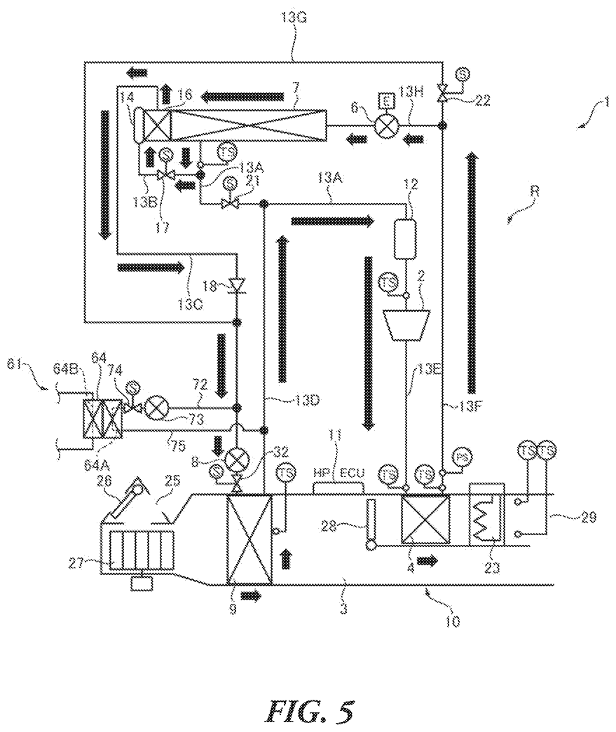

FIG. 5 illustrates the flow of refrigerant in the refrigerant circuit R to defrost the outdoor heat exchanger 7 in the cooling cycle defrosting mode. In the cooling cycle defrosting mode, the heat pump ECU 11 opens the solenoid valve 17 to allow the refrigerant having exited from the outdoor heat exchanger 7 to pass through the receiver dryer 14, the supercooling device 16 and the check valve 18 and flow into the refrigerant pipe 72. In addition, the heat pump ECU 11 opens the indoor expansion valve 8 and the solenoid valve 32 to allow the refrigerant to flow into the heat absorbing device 9 and evaporate and absorb the heat in the heat absorbing device 9. In this case, the indoor blower 27 is actuated to allow the air blown out to ventilate the heat absorbing device 9. The heat pump ECU 11 causes the refrigerant having evaporated and absorbed the heat in the heat absorbing device 9 to flow into the refrigerant pipes 13D and 13A, fully opens the outdoor expansion valve 6 and actuates the compressor 2 to allow the refrigerant to flow into the compressor 2. Then, the refrigerant with a high temperature and a high pressure having been compressed and discharged by the compressor 2 passes through the indoor condenser 4 and the outdoor expansion valve 6, and flows into the outdoor heat exchanger 7. The refrigerant with a high temperature having flowed into the outdoor heat exchanger 7 releases the heat in the outdoor heat exchanger 7 and melts the frost. The outdoor heat exchanger 7 is defrosted by the latent heat of the refrigerant. Here, during the defrosting, the outdoor blower is stopped, and, when a grille shutter is provided, it is closed.

In the cooling cycle defrosting mode, the defrosting performance depends on not only the performance of the compressor 2, but also the degree of heat absorption of the refrigerant in the heat absorbing device 9. Therefore, the auxiliary heater 23 such as an air heater (PTC heater) is appropriately actuated as an auxiliary heat source to complement the heating of the vehicle compartment. By this means, it is possible to complement the amount of heat absorbed into the refrigerant in the heat absorbing device 9, and therefore to complement the defrosting performance in the cooling cycle defrosting mode.

### <Setting Conditions of Selecting or Switching Between Defrosting Modes>

As described above, the selecting and the switching between the defrosting modes are performed based on the preset conditions. With the present embodiment, the heat pump ECU 11 presets conditions including: a selecting condition to select the defrosting mode to perform the defrosting when the defrosting needs to be started; a switching condition to switch from the hot gas defrosting mode to the heat absorption defrosting mode; operation conditions to actuate the auxiliary heat source in the heat absorption defrosting mode; and a defrosting end condition to end the defrosting.

### (1) Selecting Hot Gas Defrosting Mode or Heat Absorption Defrosting Mode

As described above, the hot gas defrosting mode is easily controlled, and can evenly remove the frost, and therefore it is preferred that the defrosting in the hot gas defrosting mode is performed as long as the frost can be removed by the hot gas defrosting mode. However, when the outdoor temperature is too low, or when it is difficult to perform the defrosting in the hot gas defrosting mode depending on the situation of the vehicle, the heat pump ECU 11 selects the heat absorption defrosting mode. For this, in the vehicle air conditioning apparatus 1, the heat pump ECU 11 sets a hot gas defrosting priority condition to preferentially select the hot gas defrosting mode in the case where the defrosting needs to be started.

The hot gas defrosting priority condition can be set by, for example, the outdoor temperature, that is, set as a threshold for the outdoor temperature. In this case, the heat pump ECU 11 preferentially selects the hot gas defrosting mode when the outdoor temperature satisfies the hot gas defrosting priority condition, but selects the heat absorption defrosting mode when the outdoor temperature does not satisfy the hot gas defrosting priority condition.

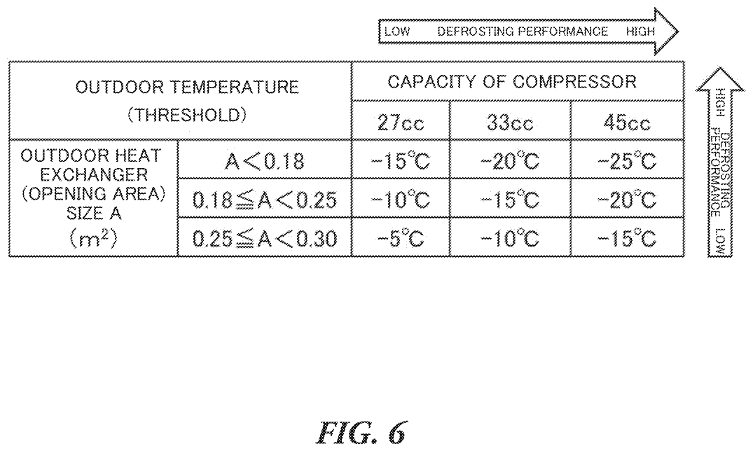

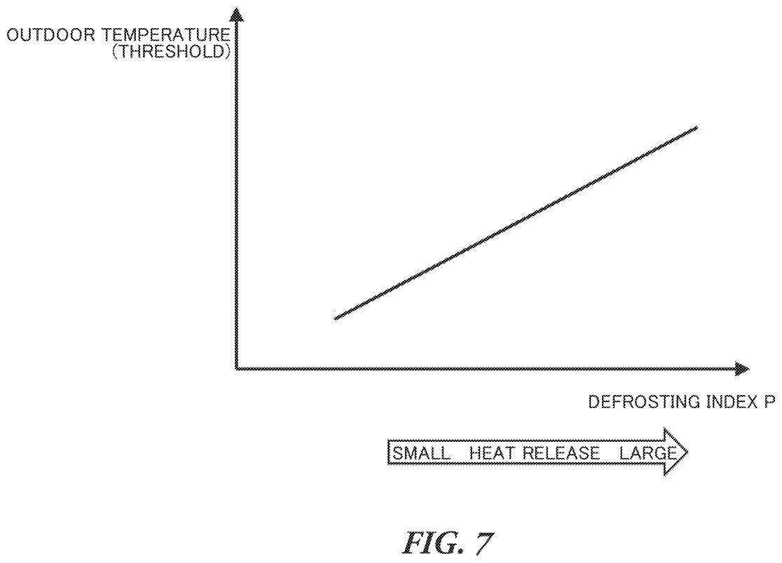

FIG. 6 illustrates the relationship among the capacity of the condenser, the opening area of the outdoor heat exchanger, and the outdoor temperature (threshold). FIG. 7 is a graph illustrating the relationship between the outdoor temperature Tam and defrosting index P. Here, the defrosting index P indicates the opening area of the outdoor heat exchanger/the capacity of the compressor, or the opening area of the outdoor heat exchanger/the maximum heat value (maximum power) of the compressor.

As illustrated in FIG. 6, the greater the capacity (volume) of the compressor or the maximum heat value (maximum power) of the compressor is, the higher the defrosting performance is, and the smaller the opening area of the outdoor heat exchanger is, the easier the defrosting is. In addition, the defrosting index P illustrated in FIG. 7 means that the higher the defrosting index P is, the greater the opening area of the outdoor heat exchanger with respect to the heat value of the compressor is, and therefore the higher the defrosting index P is, the greater the heat release required for the defrosting is. Accordingly, as illustrated in FIG. 7, the higher the defrosting index P is, the higher the outdoor temperature Tam is. The outdoor temperature Tam is conceived that the heat absorption mode is more suitable than the hot gas defrosting mode.

In this way, based on the relationship between the capacity of the compressor and the opening area of the outdoor heat exchanger, for example, threshold Tx for the outdoor temperature is set as the hot gas defrosting priority condition to preferentially select the hot gas defrosting mode as illustrated in FIG. 6. The heat pump ECU 11 preferentially selects the hot gas defrosting mode when the outdoor temperature Tam is higher than the threshold Tx, and selects the heat absorption defrosting mode when the outdoor temperature Tam is lower than the threshold Tx. Here, the heat pump ECU 11 obtains the outdoor temperature Tam detected by the outdoor temperature sensor 33, and compares the outdoor temperature Tam with the threshold Tx defined as the hot gas defrosting priority condition.

In this case, the threshold Tx is provided with hysteresis (α1 and α2), and it is preferred that the hot gas defrosting priority condition is defined as follows: when the outdoor temperature Tam≥threshold Tx+α1, the hot gas defrosting mode is selected; and when the outdoor temperature Tam≤threshold Tx−α2, the heat absorption defrosting mode is selected.

(2) Switching from Hot Gas Defrosting Mode to Heat Absorption Defrosting Mode

Meanwhile, during the defrosting in the hot gas defrosting mode, when the mode is switched to the heat absorption defrosting mode depending on the situation of the vehicle, for example, threshold Trt1 for the refrigerant temperature, or threshold Prt1 for the refrigerant pressure is set as a defrosting mode switching condition. Even though the defrosting in the hot gas defrosting mode is started, when a state in which the refrigerant temperature or the refrigerant pressure is lower than the preset threshold (the temperature threshold Trt1 or the pressure Prt1), or is little changed continues for predetermined period of time TP1, the heat pump ECU 11 switches from the hot gas defrosting mode to the heat absorption defrosting mode.

As the refrigerant temperature, for example, the temperature Ts of the refrigerant sucked into the compressor 2, the temperature Td of the refrigerant discharged from the compressor 2, and the temperature TXO of the refrigerant just after being discharged from the outdoor heat exchanger 7 are detected and used. As the refrigerant pressure, for example, pressure Ps of the refrigerant sucked into the compressor 2, the pressure Pd of the refrigerant discharged from the compressor 2, and the pressure PXO of the refrigerant just after being discharged from the outdoor heat exchanger 7 are detected and used.

### (3) Action of Auxiliary Heat Source During Defrosting in Heat Absorption Defrosting Mode

The heat pump ECU 11 also sets operation conditions to determine whether the auxiliary heat source is actuated, and operation stop conditions to stop the auxiliary heat source during the defrosting in the heat absorption defrosting mode.

In the chiller defrosting mode, when the chiller water temperature Tw (the temperature of the heat medium) is lower than temperature Twt1 set as an operation condition, the electric coolant heater (ECH) as an auxiliary heat source is actuated. Meanwhile, when the chiller water temperature Tw is higher than temperature Twt2 set as an operation stop condition, the electric coolant heater may be stopped.

In the cooling cycle defrosting mode, when the temperature Tin of the vehicle compartment is lower than temperature Tin1 set as an operation condition, the auxiliary heater 23 as an auxiliary heat source is actuated. In addition, when the temperature Tin of the vehicle compartment is higher than temperature Tin2 set as an operation stop condition, the auxiliary heater 23 may be stopped.

### (4) End of Defrosting

With the present embodiment, as the defrosting end condition to end the defrosting, threshold Trt2 for the refrigerant temperature, or threshold Prt2 for the refrigerant pressure is set. When predetermined period of time TP2 for which the temperature or the pressure of the refrigerant is higher than the preset threshold (the temperature threshold Trt2 or the pressure Prt2) has elapsed, the heat pump ECU 11 ends the defrosting mode.

### <Process of Selecting and Switching Between Defrosting Modes>

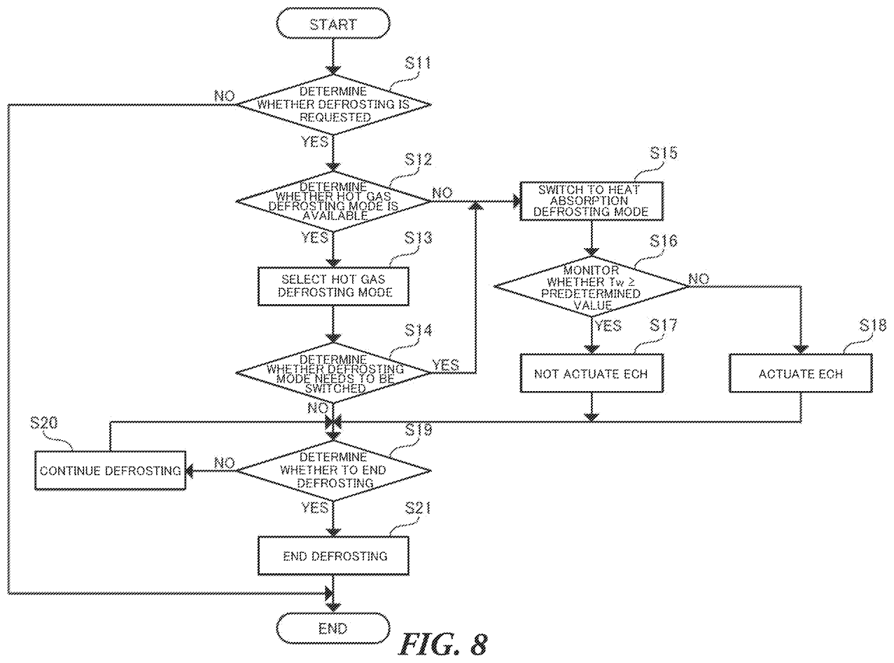

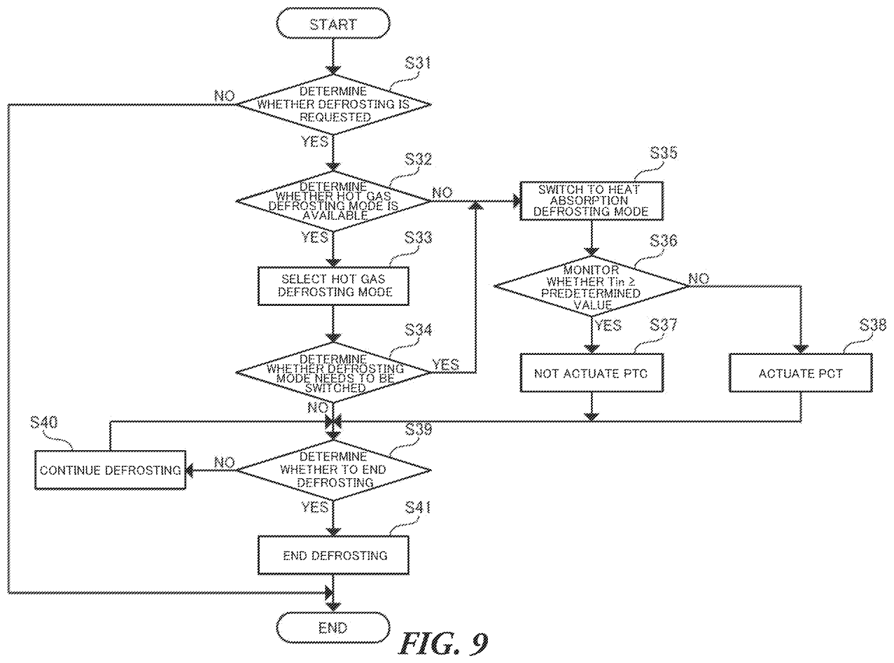

Hereinafter, selecting and switching between the defrosting modes of the vehicle air conditioning apparatus according to the present embodiment will be described with reference to the flowcharts illustrated in FIG. 8 and FIG. 9. Now, two examples will be described: (1) an example where the hot gas defrosting mode and the chiller defrosting mode are applied (FIG. 8); and (2) an example where the hot gas defrosting mode and the cooling cycle defrosting mode are applied (FIG. 9).

(1) when Hot Gas Defrosting Mode and Chiller Defrosting Mode are Used

When the defrosting operation is automatically selected or selected by manually operating the air conditioning operating device 53, the heat pump ECU 11 determines that the defrosting is requested (step S11), and obtains the outdoor temperature Tam detected by the outdoor temperature sensor 33. The heat pump ECU 11 compares the outdoor temperature Tam with the preset threshold Tx for the outdoor temperature (step S12). In the step S12, when the outdoor temperature Tam is equal to or higher than the threshold Tx, the heat pump ECU 11 selects the hot gas defrosting mode (step S13). On the other hand, when the outdoor temperature Tam is lower than the threshold Tx, the chiller defrosting mode is selected as the heat absorption defrosting mode (step S15).

After starting defrosting the outdoor heat exchanger 7 in the hot gas defrosting mode in the step S13, the heat pump ECU 11 obtains the refrigerant temperature (Ts, Td, or TXO) from one of the suction temperature sensor 44, the discharge temperature sensor 43, and the outdoor heat exchanger temperature sensor 54,

and switches from the hot gas defrosting mode to the heat absorption defrosting mode (step S15) when the state in which the refrigerant temperature is lower than the preset temperature threshold Trt1 continues for a predetermined period of time (step S14/YES). When the state in which the refrigerant temperature is lower than the preset temperature threshold Trt1 does not continue for the predetermined period of time, the step is moved to step S19 without switching the defrosting mode. Here, in the step S14, the heat pump ECU 11 may monitor the refrigerant pressure instead of the refrigerant temperature. In this case, the heat pump ECU 11 obtains the refrigerant pressure (Ps, Pd or PXO) from the discharge pressure sensor 42 or the outdoor heat exchanger pressure sensor 56, and switches from the hot gas defrosting mode to the heat absorption defrosting mode (the step S15) when the state in which the refrigerant pressure is lower than the preset pressure threshold Prt1 continues for the predetermined period of time (the step S14/YES). When the state in which the refrigerant pressure is lower than the preset pressure threshold Prt1 does not continue for the predetermined period of time, the step is moved to the step S19 without switching the defrosting mode (step S14/NO).

When the outdoor temperature Tam is lower than the threshold Tx in the step S12, and when the heat absorption defrosting mode is selected because the refrigerant temperature is lower than the threshold Trt1 or the refrigerant pressure is lower than the threshold Prt1 in the step S14, the defrosting is performed in the chiller defrosting mode as the heat absorption defrosting mode (the step S15).

During the defrosting in the chiller defrosting mode, the heat pump ECU 11 monitors whether the chiller water temperature Tw is higher than the predetermined temperature Twt1 (step S16). When the chiller water temperature Tw is higher than the predetermined temperature Twt1, the electric coolant heater is not actuated (step S17), and, on the other hand, when the chiller water temperature Tw is lower than the predetermined temperature Twt1, the electric coolant heater is actuated (step S18), and the chiller defrosting mode is continued. Here, when the chiller water temperature Tw is raised and becomes higher than the predetermined temperature Twt2 after the electric coolant heater is actuated, the electric coolant heater may be stopped.

The heat pump ECU 11 continues the defrosting until the predetermined period of time TP2 for which the refrigerant temperature Tr is higher than the preset temperature threshold Trt2, or the refrigerant pressure is higher than the preset pressure threshold Prt2 has elapsed (step S19 and step S20). When the state in which the refrigerant temperature Tr is higher than the preset temperature threshold Trt2, or the state in which the refrigerant pressure is higher than the preset pressure threshold Prt2 continues for the predetermined period of time, the heat pump ECU 11 ends the defrosting (step S21).

(2) when Hot Gas Defrosting Mode and Cooling Cycle Defrosting Mode are Used

When the defrosting operation is automatically selected or selected by manually operating the air conditioning operating device 53, the heat pump ECU 11 determines that the defrosting is requested (step S31), and obtains the outdoor temperature Tam detected by the outdoor temperature sensor 33. The heat pump ECU 11 compares the outdoor temperature Tam with the preset threshold Tx for the outdoor temperature (step S32). In the step S32, when the outdoor temperature Tam is equal to or higher than the threshold Tx, the heat pump ECU 11 selects the hot gas defrosting mode (step S33). On the other hand, when the outdoor temperature Tam is lower than the threshold Tx, the cooling cycle defrosting mode is selected as the heat absorption defrosting mode (step S35).

After starting defrosting the outdoor heat exchanger 7 in the hot gas defrosting mode in the step S33, the heat pump ECU 11 obtains the refrigerant temperature (Ts, Td, or TXO) from one of the suction temperature sensor 44, the discharge temperature sensor 43, and the outdoor heat exchanger temperature sensor 54, and switches from the hot gas defrosting mode to the heat absorption defrosting mode (step S35) when the state in which the refrigerant temperature is lower than the preset temperature threshold Trt1 continues for a predetermined period of time (step S34/YES). When the state in which the refrigerant temperature is lower than the preset temperature threshold Trt1 does not continue for the predetermined period of time, the step is moved to step S39 without switching the defrosting mode (step S34/NO). Here, in the step S34, the heat pump ECU 11 may monitor the refrigerant pressure instead of the refrigerant temperature. In this case, the heat pump ECU 11 obtains the refrigerant pressure (Ps, Pd or PXO) from the discharge pressure sensor 42 or the outdoor heat exchanger pressure sensor 56, and switches from the hot gas defrosting mode to the heat absorption defrosting mode (the step S35) when the state in which the refrigerant pressure is lower than the preset pressure threshold Prt1 continues for the predetermined period of time (the step S34/YES). When the state in which the refrigerant pressure is lower than the preset pressure threshold Prt1 does not continue for the predetermined period of time, the step is moved to the step S39 without switching the defrosting mode (step S34/NO).

When the outdoor temperature Tam is lower than the threshold Tx in the step S32, and when the heat absorption defrosting mode is selected because the refrigerant temperature is lower than the threshold Trt1 or the refrigerant pressure is lower than the threshold Prt1 in the step S34, the defrosting is performed in the cooling cycle defrosting mode as the heat absorption defrosting mode (the step S35).

During the defrosting in the cooling cycle defrosting mode, the heat pump ECU 11 monitors whether the temperature Tin of the vehicle compartment is higher than predetermined temperature Tint1 (step S36). When the temperature Tin of the vehicle compartment is higher than the predetermined temperature Tint1, the auxiliary heater 23 is not actuated (step S37), and, on the other hand, when the temperature Tin of the vehicle compartment is lower than the predetermined temperature Tint1, the auxiliary heater 23 is actuated (step S38) to continue the cooling cycle defrosting mode. Here, when the temperature Tin of the vehicle compartment is raised and becomes higher than predetermined temperature Tint2 after the auxiliary heater 23 is actuated, the auxiliary heater 23 may be stopped.

The heat pump ECU 11 continues the defrosting until the predetermined period of time for which the refrigerant temperature Tr is higher than the preset temperature threshold Trt2, or the refrigerant pressure is higher than the preset pressure threshold Prt2 has elapsed (step S39 and step S40). When the state in which the refrigerant temperature Tr is higher than the preset temperature threshold Trt2, or the state in which the refrigerant pressure is higher than the preset pressure threshold Prt2 continues for the predetermined period of time, the heat pump ECU 11 ends the defrosting (step S41).

As described above, according to the vehicle air conditioning apparatus 1 according to the embodiment, the heat pump ECU 11 can perform the plurality of defrosting modes including the hot gas defrosting mode and the heat absorption defrosting mode (chiller defrosting mode or the cooling cycle defrosting mode). In addition, the heat pump ECU 11 preferentially perform the hot gas defrosting mode which can be easily controlled and evenly remove the frost, and performs the heat absorption defrosting mode when it is difficult to perform the defrosting in the hot gas defrosting mode. Consequently, it is possible to surely and evenly remove the frost regardless of situations.

As described above, the embodiments of the present invention have been described in detail with reference to the drawings. However, the specific configuration is not limited to these embodiments, and the design can be changed without departing from the scope of the present invention.

### REFERENCE SIGNS LIST

1: vehicle air conditioning apparatus, 2: compressor,
3: air flow passage, 4: indoor condenser,
6: outdoor expansion valve, 7: outdoor heat exchanger,
8: indoor expansion valve, 9: heat absorbing device,
11: heat pump ECU (controller),
64: refrigerant-heat medium heat exchanger,
73: chiller expansion valve

1. A vehicle air conditioning apparatus comprising:
a refrigerant circuit including:
a compressor configured to compress refrigerant;
an outdoor heat exchanger configured to perform a heat exchange between the refrigerant and outdoor air; and
a heat absorption heat exchanger configured to absorb heat from a heat-absorbed subject; and
a controller configured to control the refrigerant circuit,
wherein the controller can selectively perform a plurality of defrosting modes including:
a hot gas defrosting mode to defrost the outdoor heat exchanger by the refrigerant compressed by the compressor; and
a heat absorption defrosting mode to defrost the outdoor heat exchanger by the refrigerant absorbing the heat from the heat-absorbed subject and compressed by the compressor, and
the controller sets a hot gas defrosting priority condition to preferentially select the hot gas defrosting mode.

2. The vehicle air conditioning apparatus according to claim 1, wherein:
the hot gas defrosting priority condition is set by an outdoor temperature; and
when the outdoor temperature satisfies the hot gas defrosting priority condition, the hot gas defrosting mode is preferentially selected, and when the outdoor temperature does not satisfy the hot gas defrosting priority condition, the heat absorption defrosting mode is selected.

3. The vehicle air conditioning apparatus according to claim 1, wherein the hot gas defrosting priority condition is an outdoor temperature determined based on at least one of an opening area of the outdoor heat exchanger and a capacity of the compressor.

4. The vehicle air conditioning apparatus according to claim 1, wherein during the hot gas defrosting mode, when a state in which a temperature of the refrigerant is lower than a threshold Trt1 continues for a predetermined period of time TP1, the controller switches from the hot gas defrosting mode to the heat absorption defrosting mode and performs the heat absorption defrosting mode.

5. The vehicle air conditioning apparatus according to claim 1, wherein during the hot gas defrosting mode, when a state in which a pressure of the refrigerant is lower than a threshold Prt1 continues for a predetermined period of time TP1, the controller switches from the hot gas defrosting mode to the heat absorption defrosting mode and performs the heat absorption defrosting mode.

6. The vehicle air conditioning apparatus according to claim 1, wherein the heat absorption defrosting mode includes a chiller defrosting mode in which the heat absorption heat exchanger is a refrigerant-heat medium heat exchanger configured to perform a heat exchange between heat medium circulating through a hear medium circuit and the refrigerant.

7. The vehicle air conditioning apparatus according to claim 6, wherein when a temperature of the heat medium is lower than a predetermined temperature Twt1 during the chiller defrosting mode, the controller actuates an auxiliary heat source provided in the heat medium circuit to heat the heat medium.

8. The vehicle air conditioning apparatus according to claim 1, wherein the heat absorption defrosting mode includes a cooling cycle defrosting mode in which the heat absorption heat exchanger is a heat absorbing device configured to absorb heat into the refrigerant from air supplied to a vehicle compartment.

9. The vehicle air conditioning apparatus according to claim 8, wherein when a temperature of the vehicle compartment is lower than a predetermined temperature Tint1 during the cooling cycle defrosting mode, the controller actuates an auxiliary heat source to heat air flowing into the vehicle compartment.

10. The vehicle air conditioning apparatus according to claim 1, wherein the controller ends the defrosting mode when one of a state in which a temperature of the refrigerant is equal to or higher than a preset threshold Trt2 and a state in which a pressure of the refrigerant is equal to or higher than a preset threshold Prt2 continues for a predetermined period of time TP2.
